(19) United States
(12) Patent Application Publication
(10) Pub. No.: US 2005/0238370 A1
(43) Pub. Date: Oct. 27, 2005

(54) Image forming apparatus

(76) Inventor: Akihito Kameda, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/101,582

(22) Filed: Apr. 8, 2005

(30) Foreign Application Priority Data
Apr. 14, 2004 (JP) 2004-119503 (JP)
Feb. 18, 2005 (JP) 2005-042277 (JP)

(51) Int. Cl. G03G 21/12

(52) U.S. Cl. 399/35

(57) ABSTRACT

There is provided an image-forming apparatus having a transmitting and receiving device for transmitting and receiving system information to a host computer by way of a data communication line; a detection device for detecting the amount of toner deposited on the photoreceptor in the developing unit of the image-forming apparatus; a counting device for counting the number of images to be printed; and a near-full detection device for detecting the near-full state of waste toner by using the detection device and the counting device.

### BACKGROUND OF THE INVENTION

1. Field of the Invention

The present invention relates to image-forming apparatuses such as copiers, printers, and facsimiles, etc., that reduce the occurrence of downtime.

2. Description of the Related Art

In recent years, the components of image-forming apparatuses, and toner and other consumable components in particular, have become “unitized,” as it is referred to, and the user can perform maintenance on the image-forming apparatus by exchanging the consumed unit. Machines that print documents using an image-forming apparatus have furthermore become more widespread, and the apparatus stops operation when the unit has been consumed to a fixed amount. In other words, downtime occurs. In such a case, the consumed unit must be quickly replaced to minimize downtime.

An example of such technology is disclosed in Japanese Patent Application Laid-open No. 8-152816 relating to an image-forming apparatus that can reduce the downtime caused by depleted consumable components.

Conventionally known is a system in which a sensor detects (waste toner tank near full) that the amount of toner (hereinafter referred to as “waste toner”) left as a residue on the photodetector and recovered by the cleaning unit has exceeded a fixed amount. However, since the sensor is a mechanical sensor, the time until operation of the machine is prohibited varies depending on how frequently the apparatus is used, and the actual timing for exchanging the tank is not apparent, and in certain cases, the administrator cannot adequately respond, resulting in apparatus downtime.

### SUMMARY OF THE INVENTION

The present invention was contrived in view of such circumstances, and an object thereof is to provide an image-forming apparatus that reduces the occurrence of downtime.

In accordance with the present invention, there is provided an image-forming apparatus having a transmitting and receiving device for transmitting and receiving system information to and from a host computer by way of a data communication line, comprising a detection device for detecting the amount of toner deposited on the photoreceptor in the developing unit of the image-forming apparatus; a counting device for counting the number of images to be printed; and a near-full detection device for detecting the near-full state of waste toner by using the detection device and the counting device.

### BRIEF DESCRIPTION OF THE DRAWINGS

The above and other objects, features and advantages of the present invention will become more apparent from the following detailed description taken with the accompanying drawings in which:

FIG. 1 is a block diagram showing the functional structure of the digital copier of the present invention;

FIG. 2 is a diagram showing the internal structure of the digital copier of FIG. 1;

FIG. 3 is a diagram showing the internal structure of the developing unit in the digital copier of FIG. 1;

FIG. 4 is a diagram that describes the operation for providing notification that the waste toner is near full in the digital copier of FIG. 1;

FIG. 5 is a diagram showing situations in which the near-full setting value is modified in the digital copier of FIG. 1;

FIG. 6 is a diagram showing situations in which the estimated time until the toner is near full is calculated in the digital copier of FIG. 1; and

FIG. 7 is a chart showing the relationship between the pixel count value, and the related toner transfer amount and the like.

### DESCRIPTION OF THE PREFERRED EMBODIMENTS

Described below with reference to the attached diagrams is a digital copier as an embodiment of the image-forming apparatus of the present invention.

### Embodiment 1

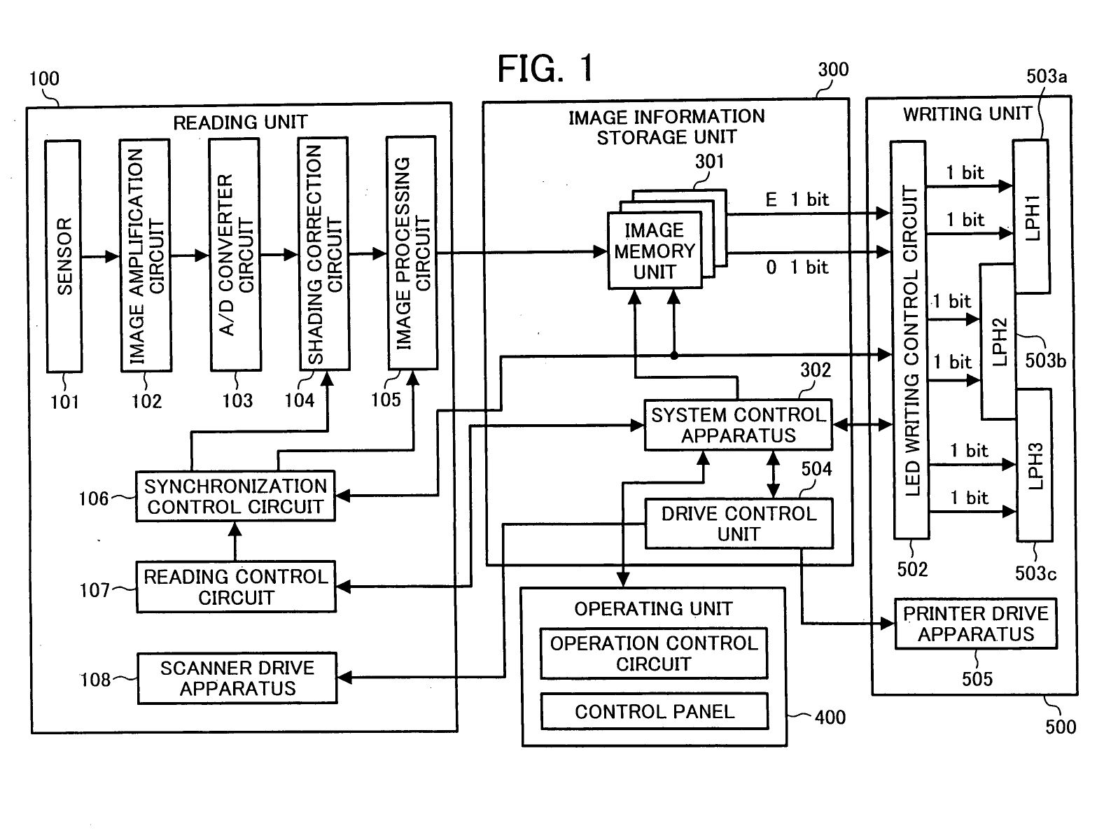

FIG. 1 is a block diagram showing the functional structure of the digital copier of the present invention. The digital copier has a document reader 100 as a reading device for reading documents, an image information storage unit 300 as a storage device for storing document information thus read, and a writing unit 500 for copying the stored information to transfer paper. Also included in the configuration is a system control apparatus 302 for controlling the execution of a series of processes, a operating unit 400 as an operating device that carries out key input to the system control apparatus, and other components.

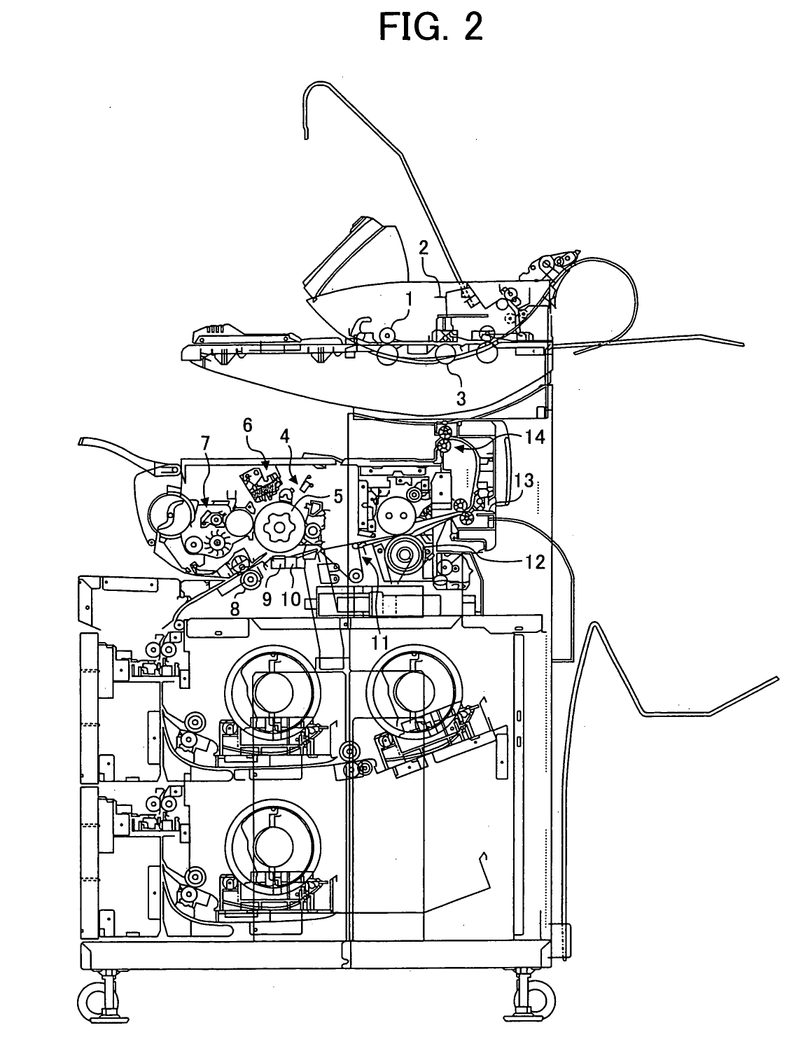

Described next is the configuration of the document reader 100 with reference to FIGS. 1 and 2.

When the operator inserts a document from the insertion port, the document is conveyed between a contact sensor 2 and a white roller 3 in accordance with the rotation of the roller 1. The document during conveyance is illuminated by light from an LED mounted in the contact sensor 2, the reflected light thereof forms an image in the contact sensor 2, and the document image information is read. The document image formed on the sensor 101 of FIG. 1 is converted to an electrical signal, and the analog signal is amplified by the image amplification circuit 102. The A/D converter circuit 103 converts the analog image signal amplified by the image amplification circuit 102 into a multi-valued digital image signal for each pixel. The converted digital image signal is synchronized with the clock output from the synchronization control circuit 106 and is then output, and distortions caused by nonuniformity in the luminous energy, soiling of the contact glass, nonuniformity of the sensitive of the sensor 101, and other factors are corrected in the shading correction circuit 104. The corrected digital image information is converted to digital recording image information in the image-processing circuit 105, and is then written to the image memory unit 301.

Described next is the configuration of the writing unit 500 and system control apparatus 302 that controls the series of processes that form on transfer paper the image signal written in the image memory unit 301.

The system control apparatus 302 has a function for controlling the entire digital copier, and drives the motor and other components via a scanner drive apparatus 108 and a printer drive apparatus 505 by using the drive control circuit 504 and data transfer in the read control circuit 107, the synchronization control circuit 106, the image memory unit 301, and the LED writing control circuit 502 to ensure the smooth conveyance of transfer paper and documents to be read.

In the writing unit 500, image signals transmitted by the synchronization signal clock from the image memory unit 301 are converted into single pixel unit bits by the LED writing control circuit 502, and are then converted and output as infrared light in the LPH503.

The process that includes the application of toner on the recording paper is described next with reference to FIG. 2.

The charged device 4 is a component that is referred to as a scorotron charger with a grid for uniformly charging the photodetector drum 5 to 1,200 V. The light emitting element array unit 6 is arranged in the form of an array of LEDs, and illuminates the photodetector drum 5 by way of an SLA (self-focusing lens array). The LED head of the light emitting element array unit 6 corresponds to LPH503 shown in FIG. 1. When the photodetector drum 5 is illuminated by LED light on the basis of the digital image information, the electric charge on the surface of the photodetector flows to the ground of the drum 5 and is eliminated. In this arrangement, the portions where the density of the document is light are such that the LEDs are not caused to illuminate, and the portions where the density of the document is considerable are such that the LEDs are caused to illuminate. An electrostatic latent image in correspondence with the light and dark portions of the image is thereby formed by the portions on the photodetector drum that are not illuminated with LED light. This electrostatic latent image is developed by a developing unit 7. The toner in the developing unit 7 is given a negative electrical charge by stirring, and since a bias of 700 V is applied, the toner adheres exclusively to the portions illuminated by LED light.

The transfer paper is selected from the automatic paper feeder or the manual paper feeder and passed under the photodetector drum 5 with a prescribed timing by a resist roller 8, and the toner image is transferred at this time by a transfer charger 9 to the transfer paper. The transfer paper is subsequently separated from the photodetector drum 5 by a separation charger 10 and conveyed from a conveyance tank 11 to a fixing unit 12, and the toner is fixed to the transfer paper therein. Transfer paper on which the toner has been fixed is conveyed forward or backward and discharged from the machine by a paper discharge tray 12 or 13.

Described next is the flow of the image signal from the image memory unit 301 to the writing unit 500.

The flow of the image signal is configured so that even (E) and odd (O) bi-valued image data is sent from the image memory unit 301 to the LED writing control circuit 502 at 25 MHz in two parallel lines. The image signal sent by the two lines is temporarily combined into a single line in the LED writing control circuit 502, then divided into two signals per LED, divided into six signals overall, and transmitted to the LED heads 503a, 503b, and 503c at 9.5 MHz.

Of the bi-valued image data that is input from the image memory unit 301 to the writing unit 500 at this time, the black data (1) transmitted to the LPH503a to 503c is counted in the LED writing control circuit 502. The count up interval is the document read interval, and once the count up interval is completed, the data is then latched and stored in the register. The stored count data is transmitted to the system control apparatus 302.

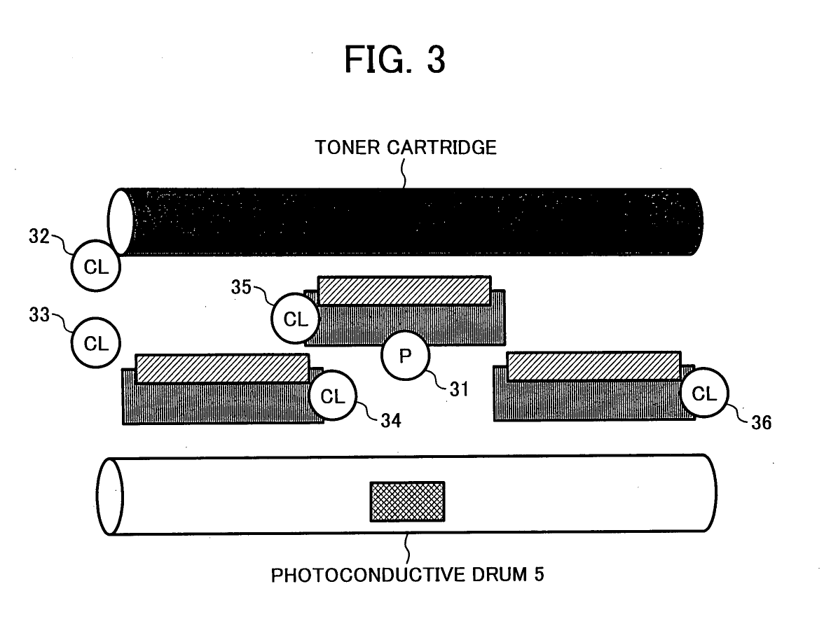

In the system control apparatus 302, the dot count value at the start of toner feeding is set as the reference value by the P sensor 31 shown in FIG. 3, the left and right dot count values and the center dot count value are compared in the CPU, and the amount of toner to be fed to the left and right of the developing unit is determined. In accordance with the amount of toner to be fed thus determined, the CPU communicates with the drive control circuit 303, and the drive control circuit 303 drives the toner supplies CL32 and 33 as well as the shutters CL34, 35, and 36.

The waste toner amount α in this case is represented by the following formula (1).

The toner amount αₙ used for a single copy in a developing unit is

$${α}_{n} = {m}_{1} \times \frac{S}{N} \times ( {D}_{n} \div \frac{{D}_{all}}{N} ) \times K + ( {T}_{bias} \times {V}_{drum} \times \frac{H}{N} - \frac{S}{N} \times ( {D}_{n} \div \frac{{D}_{all}}{N} ) \times K ) \times {m}_{2} \qquad Eq . ( 1 )$$

where N is the number of divisional units in the developing unit, m₁ is the toner deposited on the image unit (mg/cm²), m₂ is the toner deposited on the surface portion (mg/cm²), S is the surface area of the recording paper (cm²) , Dₙ is the number of dots written in a developing unit, Dₐₗₗ is the total number of dots on a single recording paper, K is the correction coefficient, T_{bias} is the applied length of time (sec) of the bias, V_{drum} is the linear velocity (cm/sec) of the photodetector, and H is the effective developing width (cm).

From the formula (1) above, the toner amount α on a single sheet (surface area S) is

$$α = {\sum }_{n = 1}^{N} {α}_{n} \qquad Eq . ( 2 )$$

The total toner amount β used in image formation is therefore represented by the following formula (3).
β=Σα Eq. (3)

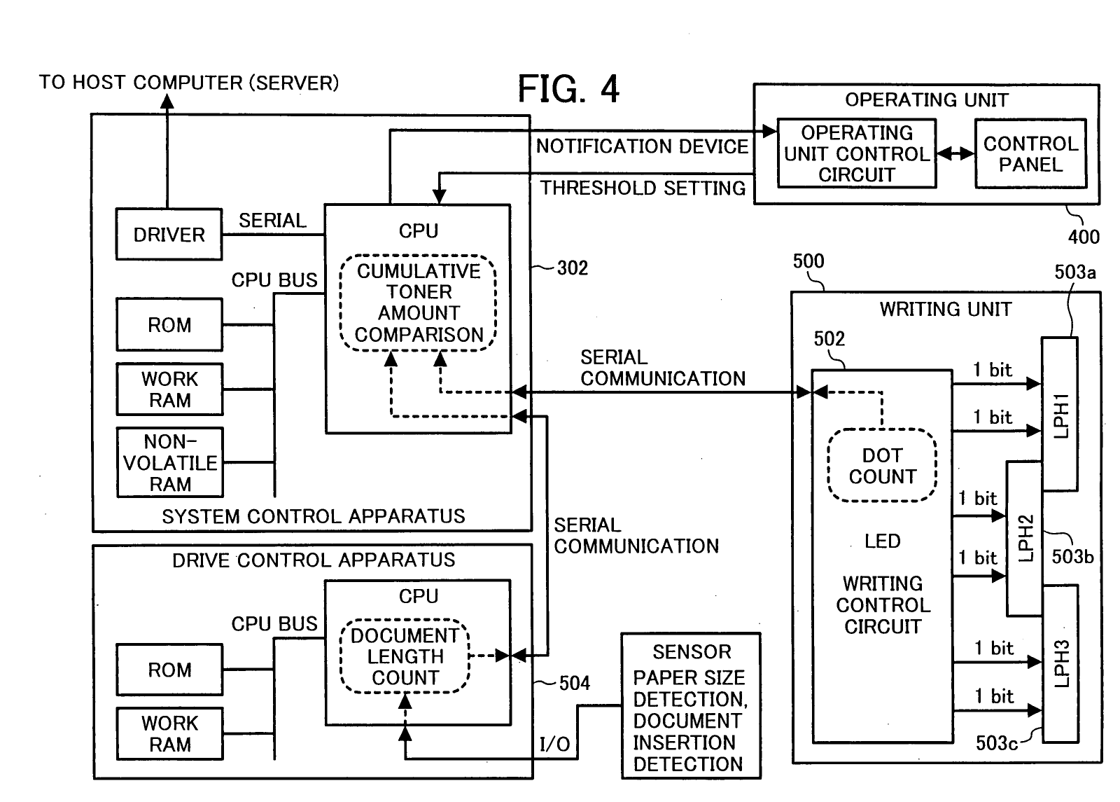

The total amount of waste toner (toner feed amount−β) calculated by using the above formula is stored in nonvolatile RAM in the main unit and compared with the threshold value preset in the CPU, and if the total amount is greater than the threshold value, the operator is notified (waste toner near full), the information is displayed on the control panel, and the host computer is notified by way of a communication line, as shown in FIG. 4

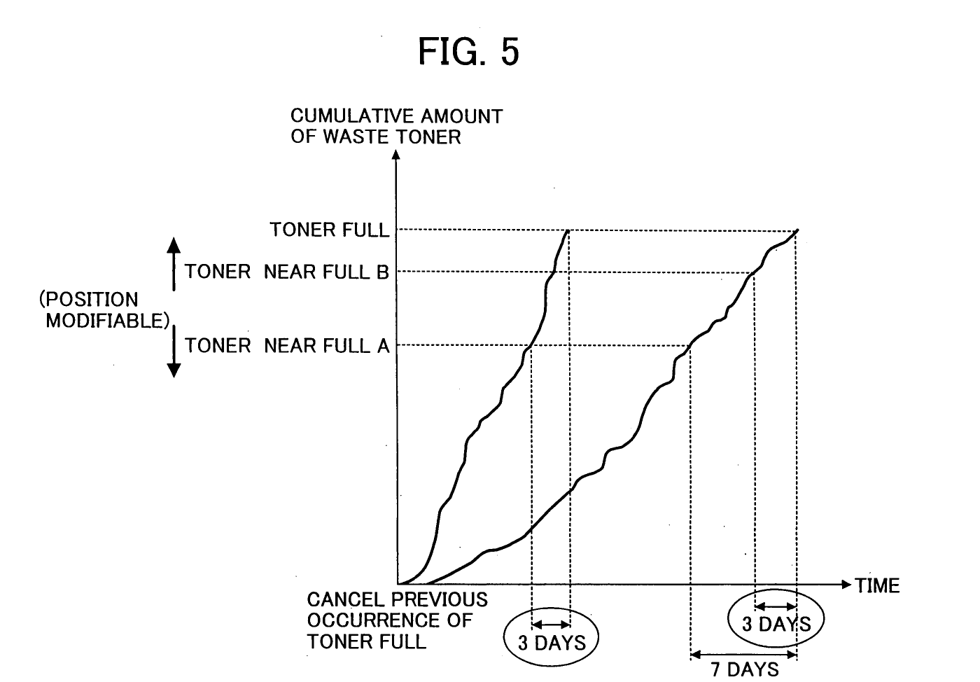

The threshold value can be modified using the control panel 400 and can be set by the operator in association with the frequency of use of the apparatus. The workload of the operator can be reduced by coordinating the devices in the host system so as to provide notification that the waste toner will be full in three days, for example, as shown in FIG. 5.

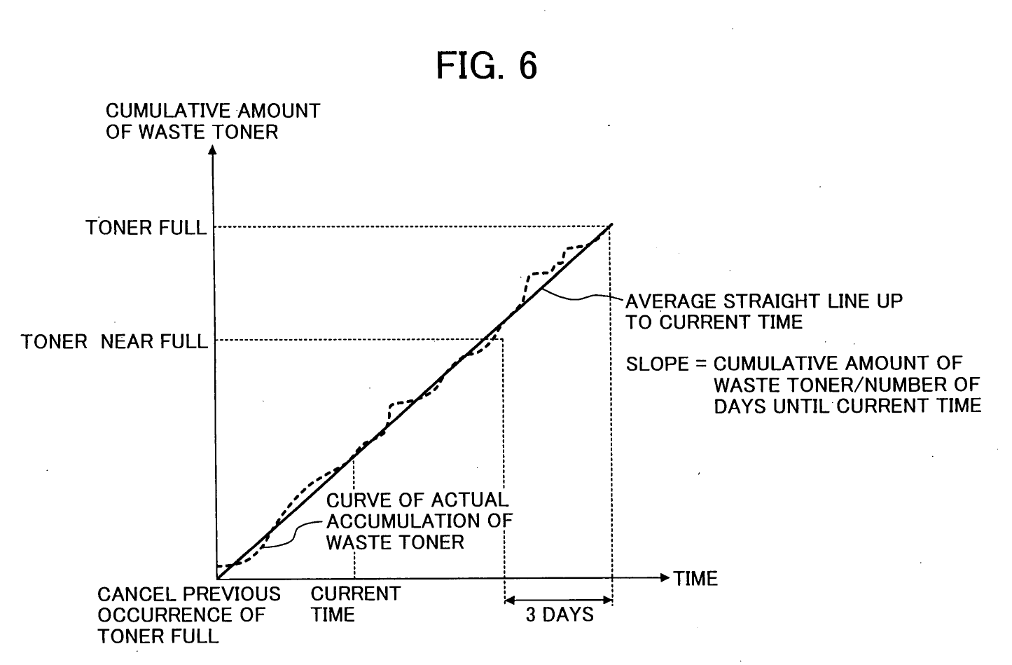

A configuration is also possible in which a time function and a nonvolatile memory for storing the time function are provided inside the apparatus, as shown in FIG. 6, the time when the previous near-full state or full state was canceled and the time when the near-full state occurred in the current cycle are compared, and if there is a device for calculating the estimated remaining time until the toner is full in the current cycle, the time remaining until full is set based on the frequency of use whereby the host computer is notified when the time remaining until a full state is reached is three days, for example, and the administrator's work of setting the threshold limit can therefore be eliminated.

It is apparent from the above description that using the image-forming apparatus of the present embodiment allows the host computer to manage the state of the waste toner without the use of a dedicated sensor, facilitates administrator management, and further allows the downtime of the apparatus to be reduced.

The near-full state can be set in association with the frequency of use, and the workload of the administrator can be lightened and the downtime can be reduced by coordinating the time from “toner near full” to “toner full” with the other devices in the host system.

It is also possible to dispense with the administrator's work of setting the threshold.

### Embodiment 2

Described next is the digital copier of the present embodiment, but the following diagrams are the same as FIGS. 1 to 6: the block diagram showing the functional structure of the digital copier, the diagram showing the internal structure of the digital copier, the diagram that describes the operation for providing notification that the waste toner is near full, the diagram showing situations in which the near-full setting value is modified, and the diagram showing situations in which the estimated time until the toner is near full is calculated, and a description of the common components is omitted.

The process that includes the application of toner on the recording paper is described next with reference to FIG. 2.

The charged device 4 is a component that is referred to as a scorotron charger with a grid for uniformly charging the photodetector drum 5 to 1,200 V. The light emitting element array unit 6 is arranged in the form of an array of LEDs with a density of 600 elements per inch (25.4 mm), and achieves a writing density of 600 dpi. The light emitted from the LED illuminates the photodetector drum 5 by way of an SLA (self-focusing lens array). The LED head of the light emitting element array unit 6 corresponds to LPH503 shown in FIG. 1. The LPH503a to c each have a light-emitting element with 7,400 dots, and cover a printing width of about 313 mm. The three LPH503a to c are disposed so as to overlap by 10 mm, and can print overall with 21,730 pixels per line, and a width of about 920 mm. When the photodetector drum 5 is illuminated by LED light on the basis of the digital image information, the electric charge on the surface of the photodetector flows to the ground of the drum 5 and is eliminated. In this arrangement, the portions where the density of the document is light are such that the LEDs are not caused to illuminate, and the portions where the density of the document is considerable are such that the LEDs are caused to illuminate. An electrostatic latent image in correspondence with the light and dark portions of the image is thereby formed by the portions on the photodetector drum that are not illuminated by LED light. This electrostatic latent image is developed by a developing unit 7. The toner in the developing unit 7 is given a negative electrical charge by stirring, and since a bias of 700 V is applied, the toner adheres exclusively to the portions illuminated by LED light.

The transfer paper is selected from the automatic paper feeder or the manual paper feeder and passed under the photodetector drum 5 with a prescribed timing by a resist roller 8, and the toner image is transferred at this time by a transfer charger 9 to the transfer paper. The initial value of the transfer current is 60 μA. The amount of toner deposited on the drum 5 and the amount of toner transferred varies in accordance to modifications made to the series of imaging conditions (charging voltage of the drum, bias voltage of the toner, transfer current, and the like). The charging voltage of the drum can be set in steps of 50 V between 1,100 V and 1,300 V, and the bias voltage of the toner can be set in steps of 50 V between 600 V and 800 V. The transfer current can be set in intervals of 1 μA between 10 μA and 230 μA. The setting may be carried out automatically by checking the imaging conditions at the time of power ON, or the value may be directly set from the control panel 400.

The transfer paper is subsequently separated from the photodetector drum 5 by the separation charger 10 and conveyed from the conveyance tank 11 to the fixing unit 12, and the toner is fixed to the transfer paper therein. Transfer paper on which the toner has been fixed is conveyed forward or backward and discharged from the machine by a paper discharge tray 13 or 14.

Described next is the flow of the image signal from the image memory unit 301 to the writing unit 500.

The flow of the image signal is configured so that even (E) and odd (O) bi-valued image data is sent from the image memory unit 301 to the LED writing control circuit 502 at 25 MHz in two parallel lines. The image signal sent by the two lines is temporarily combined into a single line in the LED writing control circuit 502, divided into two signals per LED, divided into six signals overall, and transmitted to the LED heads 503a, 503b, and 503c at 9.5 MHz.

Of the bi-valued image data input from the image memory unit 301 to the writing unit 500 at this time, the black data (1) transmitted to the LPH503a to 503c is counted in the LED writing control circuit 502. The count up interval is the interval in which actual writing is performed by the LPH503, and once the count up interval is completed, the data is then latched and stored in the register. The writable length is a maximum of 1,300 mm, and is therefore about 30,000 lines. Therefore, the count value is a maximum of about 222,000,000. The stored count data is transmitted to the system control apparatus 302.

In the system control apparatus 302, the deposited amount of toner of the developers is quantified by the value of the P sensor 31 and the dot count of writing control, and the result is stored in the RAM in the system control apparatus 302. The dot count values corresponding to the developers are counted by image transfer, the toner density is detected by the P sensor in the center developer, and the toner is fed when the density has decreased. The amount of toner fed to the left and right developers at this time is determined by comparing the center dot count value and the left and right dot count values in the CPU. In accordance with the amount of toner to be fed thus determined, the CPU communicates with the drive control circuit 303, and the drive control circuit 303 drives the toner supplies CL32 and 33 as well as the shutters CL34, 35, and 36.

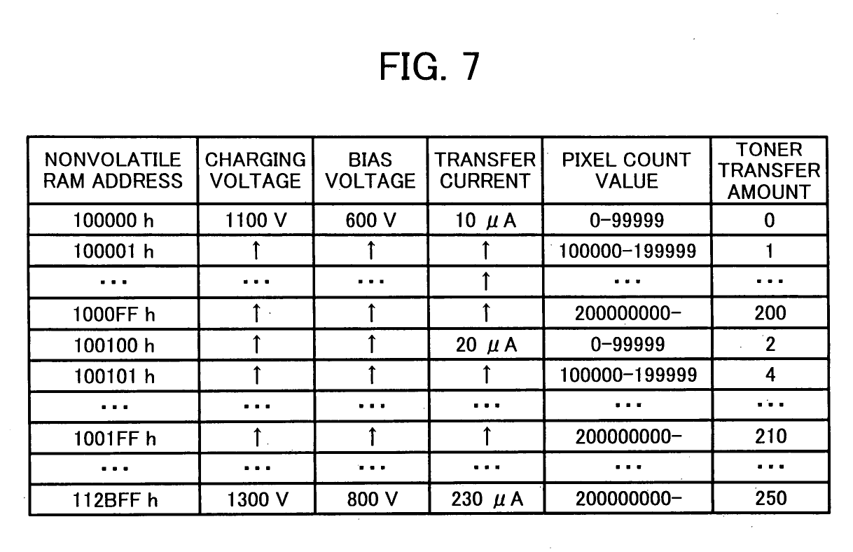

A plurality of tables of pixel count values and toner transfer amounts corresponding thereto are stored in advance in the nonvolatile RAM in the system control apparatus 302 in correspondence with the imaging (*1) conditions for forming images, as shown in FIG. 7. In other words, the system has a table of pixel count values and toner transfer amounts that correspond thereto in accordance with the setting values of the charging voltage of the drum, the bias voltage of the toner, and the transfer current. Since the transfer amount does not vary considerably if the setting values are slightly modified, the charging voltage of the drum and the bias voltage of the toner in the table are modified in steps of 50 V, and the transfer current in the table is modified in steps of 20 μA. The table to be used is determined from the plurality of tables on the basis of the imaging conditions, and the toner transfer amount is computed in accordance with the pixel count value of the black pixels to be transferred to LPH503a to 503c using the table thus determined.

The waste toner amount α in this situation is expressed in the following formula (4).
α=β−γ Eq. (4)

In the formula, α is the waste toner amount, β is the toner fed amount, and γ is the toner transfer amount.

The total amount of toner δ used in image formation is therefore expressed in the following formula (5).
δ=Σα Eq. (5)

In the formula, δ is the total amount of waste toner.

The total amount of waste toner δ calculated using the formula above is stored in the nonvolatile RAM of the main system and compared with the preset threshold in the CPU, as shown in FIG. 4. If the total exceeds the threshold value, the operator is notified (waster toner near full), the notification is displayed in the control panel, and the host computer is notified by way of a communication line.

The threshold value can be modified using the control panel 400 and can be set by the operator in association with the frequency of use of the apparatus. The workload of the operator can be reduced by coordinating the devices in the host system so as to provide notification that the waste toner will be full in three days, for example, as shown in FIG. 5.

A configuration is also possible in which a time function and a nonvolatile memory for storing the time function are provided inside the apparatus, as shown in FIG. 6, the time when the previous near-full state or full state was canceled and the time when the near-full state occurred in the current cycle are compared, and if there is a device for calculating the estimated remaining time until the toner is full in the current cycle, the time remaining until full is set based on the frequency of use whereby the host computer is notified when the time remaining until a full state is reached is three days, for example, and the administrator's work of setting the threshold limit can therefore be eliminated.

It is apparent from the above description that using the image-forming apparatus of the present embodiment allows the host computer to manage the state of the waste toner without the use of a dedicated sensor in the same manner as in example 1 described above, facilitates administrator management, and further allows the downtime of the apparatus to be reduced.

The near-full state can be set in association with the frequency of use, and the workload of the administrator can be lightened and the downtime can be reduced by coordinating the time from “toner near full” to “toner full” with the other devices in the host system.

It is also possible to dispense with the administrator's work of setting the threshold.

In accordance with the present embodiment, the state of the waste toner can be managed by the host computer without using a dedicated sensor, the system is easily managed by the administrator, and the apparatus downtime can be reduced by providing an image-forming apparatus having a transceiver for transmitting and receiving system information to and from a host computer by way of a data communication line, comprising a detection device for detecting the amount of toner deposited on the photoreceptor in the developing unit of the image-forming apparatus; a counting device for counting the number of images to be printed; and a near-full detection device for detecting the near-full state of waste toner by using the detection device and the counting device.

Various modifications will become possible for those skilled in the art after receiving the teachings of the present disclosure without departing from the scope thereof.

1. An image-forming apparatus having transmitting and receiving means for transmitting and receiving system information to and from a host computer by way of a data communication line, comprising:
detection means for detecting the amount of toner deposited on the photoreceptor in the developing unit of the image-forming apparatus;
counting means for counting the number of images to be printed; and
near-full detection means for detecting the near-full state of waste toner by using the detection means and the counting means.

2. The image-forming apparatus as claimed in claim 1, further comprising setting modification means for modifying the setting value whereby it is determined by the near-full detection means that a waste toner tank is in a near-full state.

3. The image-forming apparatus as claimed in claim 2, further comprising calculating means for comparing the time when the previous near-full state or full state was canceled and the time when the near-full state occurred in the current cycle, and calculating the estimated remaining time until reaching a full state in the current cycle.

4. The image-forming apparatus as claimed in claim 2, further comprising display means for displaying information indicating the near-full state on a control portion, and notification means for notifying the host computer of the near-full state by using the transmitting and receiving means when the near-full detection means detects the waste toner to be near full.
